(19) United States
(12) Patent Application Publication
(10) Pub. No.: US 2018/0196666 A1
(43) Pub. Date: Jul. 12, 2018

(54) SYSTEM AND METHOD FOR MANAGING DYNAMIC DESIGN DATA FOR A VIRTUAL ENVIRONMENT

(71) Applicant: Machine Zone, Inc., Palo Alto, CA (US)

(72) Inventors: Nathan Spencer, Redwood City, CA (US); Dwight Winkler, Newark, CA (US); Garth Gillespie, Palo Alto, CA (US)

(21) Appl. No.: 15/866,682

(22) Filed: Jan. 10, 2018

Related U.S. Application Data
(60) Provisional application No. 62/444,979, filed on Jan. 11, 2017.

(51) Int. Cl. G06F 8/71; G06T 19/00; G06T 19/20; G06F 8/34

(52) U.S. Cl. CPC G06F 8/71; G06F 8/34; G06T 19/20; G06T 19/003

(57) ABSTRACT

Implementations of the present disclosure are directed to a computer-implemented method, a system, and an article for facilitating the deployment of virtual environment design data, thus creating new experiences for users of the environment, without needed to redeploy the entire codebase or core processing functions of the application that instantiates the environment. In one embodiment, a design tool receives environment design parameters for a virtual environment (such as a setting for an online multi-player game) that include elements defined by the design parameters and a primary functional codebase and creating versions of the virtual environment, each version comprising a subset of the design parameters independent of the primary functional codebase. The versions are assigned to one or more users of the virtual environment and distributed to the users without requiring distribution of the primary functional codebase.

### CROSS-REFERENCE TO RELATED APPLICATIONS

This application claims the benefit of U.S. Provisional Patent Application No. 62/444,979, filed Jan. 11, 2017, the entire contents of which are incorporated by reference herein.

### BACKGROUND

The present disclosure relates to the design and management of virtual environments and, in particular, to systems and methods for dynamically designing and deploying design data and parameters in a virtual environment.

In general, a virtual world may be used to simulate real-world environments or provide the backdrop for online games in which hundreds of thousands or even millions of players interact with each other and the virtual environment. The virtual environment may be comprised of innumerous different “elements” or “things”—from outdoor scenes and landscapes to buildings and cityscapes to pieces of furniture, tools, or other objects. Each of these elements may have its own parameters and characteristics, which when taken together define what the entire virtual environment looks like and how the participants interact with the elements in the environment.

In order to effect changes in the environment and to the elements, these parameters must be updated and deployed into a production environment. This can be challenging when a large number of users are interacting with the environment and the updates must be implemented in real-time. It is desirable for such updates to be deployed in a manner that does not interrupt or compromise the users' experience within the virtual environment.

### SUMMARY

Implementations of the systems and methods described herein can be used to manage operational parameters and design data in a virtual environment, including, for example, multi-player online games (e.g., massively multiplayer online games and the like). The design data can include, for example, user events that are created when users (alternatively referred to herein as “players”) provide input to client devices for interacting with the online game or a virtual environment for the online game.

In a virtual environment or online game, each element of the environment (a “feature”) can be composed of various values which define how participants and other features view and interact with the feature. The definition and adjustment of these values shapes the user's experience and overall scope of the environment. For example, an environment may include features such as buildings, natural elements (e.g., lakes, mountains, etc.), vehicles, and other objects. Each feature may include attributes that define its size, shape, function, and other parameters, collectively referred to as “design data.” Users' engagement with and loyalty to virtual environments and online games increases if new features are introduced frequently, consistently and without interrupting the users' experience.

As such, processes for defining and implementing design data in these environments (and thus new features) that utilize workflow processes and architectures that address these concerns and that are decoupled from the base code deployment can add significant value. The techniques and supporting systems described herein allow for rapid, data-driven development of features without the need for a redeployment of the base code that implements the virtual environment. This allows design teams to constantly drive new features and content releases on an on-demand basis, thus maximizing user engagement and facilitating multiple live versions of existing design data, which can be administered by a design data tool through which design data is uploaded, versioned, managed, and released.

In one aspect, the subject matter described in this specification relates to a computer-implemented method. The method includes receiving a plurality of design parameters (which may include, for example, new design data and/or modifications to existing design data) for a virtual environment (such as a setting for an online multi-player game) that include elements defined by the design parameters and a primary functional codebase and creating versions of the virtual environment, each version comprising a subset of the design parameters independent of the primary functional codebase. The versions are assigned to one or more users of the virtual environment and distributed to the users without requiring distribution of the primary functional codebase.

In some embodiments, distribution of the versions may be initiated in response to a request from the user associated with the version, in response to the user instantiating the virtual environment on a client device, or, in some cases, independent of any user activity or action. In some implementations, subsequent versions may be assigned to subsequent users of the virtual environment, such that each user interacts with the virtual environment according to the users' assigned version. In some embodiments, different variants maybe created from one or more versions. Variants may be attributed, for example, to a particular geographical region, such that users of the virtual environment within the geographical region are assigned the variant associated with the geographical region. In some cases, a variant may be unique to a single user. In some embodiments, versions may be designated as subject to one or more release rules (e.g., a timestamp) such that the release occurs only when the rules are satisfied. Newly created versions may, in some cases, inherit design parameters from existing versions, such that only a subset of design parameters need be specified for a new version. In certain instances, prior to distributing the versions to the user, a determination is made as to whether the version conflicts with a design parameter of a previously released version, and not permitting release of the version until such conflict is designated as resolved or the conflicting design parameter is abandoned.

In another aspect, the subject matter described herein relates to a system. The system includes one or more computer processors programmed to perform operations comprising receiving a plurality of design parameters (which may include, for example, new design data and/or modifications to existing design data) for a virtual environment (such as a setting for an online multi-player game) that include elements defined by the design parameters and a primary functional codebase and creating versions of the virtual environment, each version comprising a subset of the design parameters independent of the primary functional codebase. The versions are assigned to one or more users of the virtual environment and distributed to the users without requiring distribution of the primary functional codebase.

In some embodiments, distribution of the versions may be initiated in response to a request from the user associated with the version, in response to the user instantiating the virtual environment on a client device, or, in some cases, independent of any user activity or action. In some implementations, subsequent versions may be assigned to subsequent users of the virtual environment, such that each user interacts with the virtual environment according to the users' assigned version. In some embodiments, different variants maybe created from one or more versions. Variants may be attributed, for example, to a particular geographical region, such that users of the virtual environment within the geographical region are assigned the variant associated with the geographical region. In some cases, a variant may be unique to a single user. In some embodiments, versions may be designated as subject to one or more release rules (e.g., a timestamp) such that the release occurs only when the rules are satisfied. Newly created versions may, in some cases, inherit design parameters from existing versions, such that only a subset of design parameters need be specified for a new version. In certain instances, prior to distributing the versions to the user, a determination is made as to whether the version conflicts with a design parameter of a previously released version, and not permitting release of the version until such conflict is designated as resolved or the conflicting design parameter is abandoned.

In another aspect, the subject matter described herein relates to a system. The system includes one or more computer processors programmed to perform operations comprising instantiation of instantiation of a data design tool, a versioning service and a plurality of content distribution nodes. The data design tool receives user input including design parameters for a virtual environment (such as an online, multi-player game), the virtual environment comprising elements defined by the design parameters and a primary functional codebase. The versioning service facilitates the creation of versions of the virtual environment, each version comprising a subset of the design parameters independent of the primary functional codebase and the assigning of the versions to a user of the virtual environment. The content distribution nodes distributed the versions to the user of the virtual environment without requiring distribution of the primary functional codebase.

In some embodiments, distribution of the versions by the content distribution nodes may be initiated in response to a request from the user associated with the version, in response to the user instantiating the virtual environment on a client device, or, in some cases, independent of any user activity or action. In some implementations, the versioning service may assign subsequent versions to subsequent users of the virtual environment, such that each user interacts with the virtual environment according to the users' assigned version. In some embodiments, the versioning service may create different variants from the versions. Variants may be attributed, for example, to a particular geographical region, such that users of the virtual environment within the geographical region are assigned the variant associated with the geographical region. In some cases, a variant may be unique to a single user. In some embodiments, versions may be designated as subject to one or more release rules (e.g., a timestamp) such that the release occurs only when the rules are satisfied. Newly created versions may, in some cases, inherit design parameters from existing versions, such that only a subset of design parameters need be specified for a new version. In certain instances, prior to distributing the versions to the user, a determination is made as to whether the version conflicts with a design parameter of a previously released version, and not permitting release of the version until such conflict is designated as resolved or the conflicting design parameter is abandoned.

In another aspect, the subject matter described in this specification relates to an article. The article comprises a non-transitory computer-readable medium with instructions stored thereon that, when executed by a computer processor, causes the computer processors to receive a plurality of design parameters for virtual environment which includes elements defined by the design parameters and a primary functional codebase. Execution of the instructions also creates versions of the virtual environment, each version comprising a subset of the design parameters independent of the primary functional codebase, assigns the versions to a user of the virtual environment, and distributes the versions to the user of the virtual environment without requiring distribution of the primary functional codebase.

Elements of embodiments described with respect to a given aspect of the invention can be used in various embodiments of another aspect of the invention. For example, it is contemplated that features of dependent claims depending from one independent claim can be used in apparatus, systems, and/or methods of any of the other independent claims

### DESCRIPTION OF THE DRAWINGS

A more complete appreciation of the invention and many attendant advantages thereof will be readily obtained as the same becomes better understood by reference to the following detailed description when considered in connection with the accompanying drawings. In the drawings, like reference characters generally refer to the same parts throughout the different views. Further, the drawings are not necessarily to scale, with emphasis instead generally being placed upon illustrating the principles of the invention.

FIG. 1 is a schematic diagram of an example system for managing design data for a virtual environment in accordance with the present disclosure.

FIG. 2 illustrates various constructs that define and implement design data in a virtual environment in accordance with the present disclosure.

FIG. 3 is a flow chart illustrating a process for implementing new features within a virtual environment in accordance with the present disclosure.

FIG. 4 is an illustrative set of spreadsheets that may be used to collect and manage design data for implementing versions and features within a virtual environment in accordance with the present disclosure.

FIG. 5 is an illustrative screen capture showing a data tool console for implementing versions and features within a virtual environment in accordance with the present disclosure.

FIG. 6 is an illustrative screen capture showing an application page for assigning a feature to a version of a virtual environment in accordance with the present disclosure.

FIG. 7 is an illustrative screen capture showing an application page for assigning a hotfix to a version of a virtual environment in accordance with the present disclosure.

FIGS. 8a and 8b are illustrative screen captures showing application pages for creating and managing rules within a virtual environment in accordance with the present disclosure.

FIG. 9 is an illustrative screen capture showing an application page for defining a widget used to define aspects of a virtual environment in accordance with the present disclosure.

FIG. 10 is an illustrative screen capture showing an application page for managing variants of a virtual environment in accordance with the present disclosure.

FIG. 11 is an illustrative screen capture showing an application page for editing parameters associated with variants of a virtual environment in accordance with the present disclosure.

FIG. 12 is an illustrative screen capture showing an application page for deploying features into a virtual environment in accordance with the present disclosure.

FIG. 13 is an illustrative screen capture showing an application page for managing the deployment of versions of a virtual environment in accordance with the present disclosure.

FIG. 14 is a work flow illustrating a process for deploying design data into a virtual environment in accordance with the present disclosure.

FIG. 15 is a work flow illustrating an architecture for deploying design data into a virtual environment in accordance with the present disclosure.

FIG. 16 is a flow chart illustrating a process for creating and validating a new version of a virtual environment in accordance with the present disclosure.

FIG. 17 is a flow chart illustrating a process for creating and validating a new variant of a virtual environment in accordance with the present disclosure.

FIG. 18 is a flow chart illustrating a process for deploying a new version of a virtual environment in accordance with the present disclosure.

### DETAILED DESCRIPTION

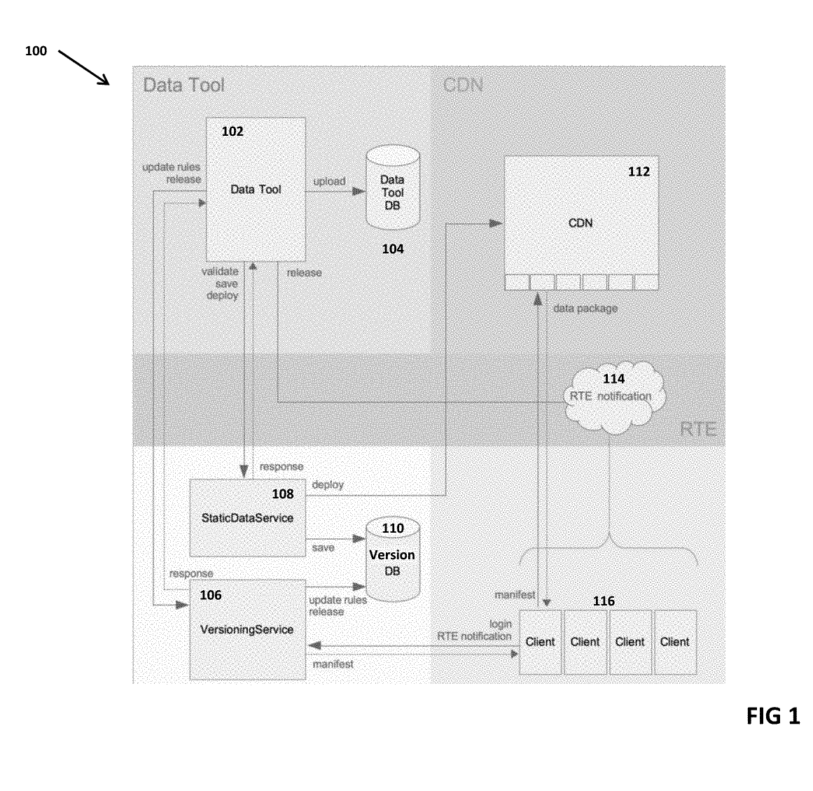

FIG. 1 illustrates an example system 100 for managing the creation, management and distribution of parameters and design data related to a virtual environment and the elements that comprise the environment. As used herein, a virtual environment can be any online environment in which users view, interact with, purchase and sell, and/or use virtual items and elements such as buildings, vehicles, virtual beings, weapons, toys, etc. In some instances, the elements are used according to rules, creating a game environment in which users can compete against each other to amass items, wealth, strength, etc. In aspects of the invention described herein, the parameters and data that define the presentation and/or use of the elements may be created, stored and deployed separately from the functional codebase that instantiates the virtual environment. For example, there may be a set of functional code that is common to all users, regardless of level, locale, etc. that creates the structure of the environment, whereas the design data creates or “fills in the details” of the elements and can be customized across and among the user base.

Generally, and referring to FIG. 1, the system 100 includes a design data tool 102 and a corresponding data tool database 104, a versioning service 106 with an associated static data service 108 and version database 110, and a CDN (content distribution node or nodes) 112. In some embodiments, an RTE (real-time event) notification service 114 provides real-time or near real-time messaging capabilities among the components of the system 100. One exemplary architecture of the RTE notification service 114 comprises a publication/subscription service (“PubSub”) as described in commonly-owned U.S. patent application Ser. No. 15/442,036, the entire disclosure of which is incorporated herein by reference. Users of the versions of the virtual environment access and interact with the environment from one or more clients 116. The design data tool 102 provides an application interface through which environment administrators and designers can upload, maintain and deploy design data related to the virtual environment. The versioning service 106 provides an application programming interface through which the data tool loads and persists static data, and the static data service 108 distributes the appropriate data to the CDN 112 where the data is packaged and stored for subsequent distribution to clients 116.

More specifically, the data communication flows among the various components can be described as follows. Design data entered by users in the design data tool 102 is periodically uploaded to and saved in the data tool database 104, from which it can be retrieved/revised, etc. as users create new design data. Once a user has completed (or wishes to check the validity of) a set of design data using the design data tool 102, the design data is sent to the static data service 108 for validation. Once validated at the static data service 108, a response is sent back to the design data tool 102, indicating the versioning and release process may begin for that set of design data, and the update rules for the set of design data is sent to the versioning service 106. The newly created design data and its associated update/release rules are then saved to the version database 110. When the version is approved and ready for deployment (either immediately or according to one or more release rules), the newly created version is deployed to the CDN 112 and made available for deployment to the clients 116. The clients 116 can be appropriately notified of the newly created version via, for example, the RTE notification service 114. When clients 116 subsequently login to the service, they are provided the current core application manifest, as well as the appropriate data package from the CDN 112, which contains the new design data for the particular client(s) 116. Alternatively, if the client(s) 116 are already logged into the service at the time of receiving the notification from RTE notification service 114, the current core application manifest and the appropriate data package from the CDN 112 can be (automatically) downloaded or otherwise provided to the client(s) 116 in the background.

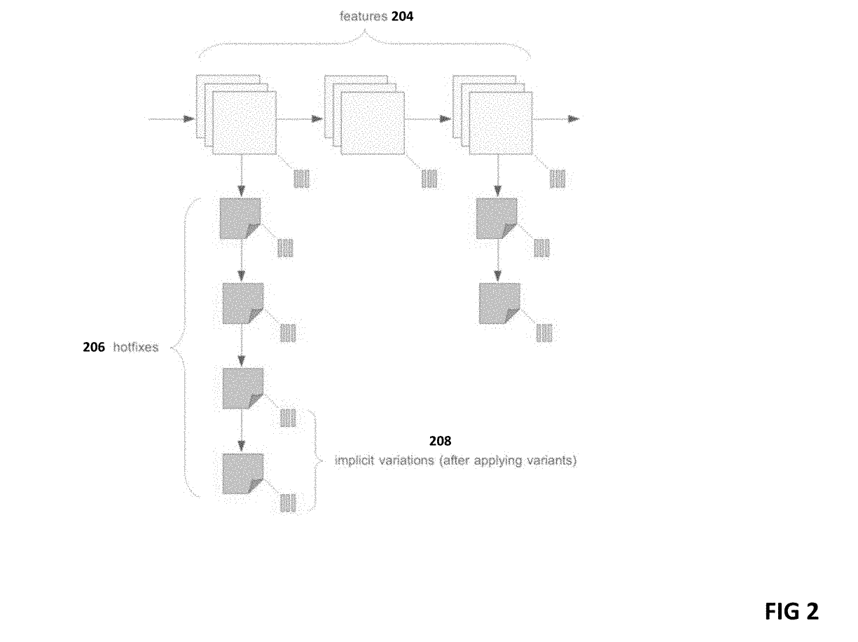

FIG. 2 illustrates the different data classifications that may be designed and deployed using the system 100. The design data may generally be grouped into one of three classifications: features 204, hotfixes 206 or variants 208. Other design data classifications are possible. Data entered into any of the three classifications may contain new static data, modifications to existing static data, or both.

Features 204 are the primary unit of measurement in data progression as the system 100 revolves around sets of features, or feature sets. Features 204 can be comprised of design data entered into the design data tool 102 using, for example, collated spreadsheets, lists, structured documents, or other formats. In some instances, features 204 may be created and managed by specialized design team members and uploaded into the design datatool 102, where the data persists and is eventually deployed and transformed into static data. Any number of pending features may be retained and managed in the design data tool 102, and a full history of deployed features is retained. Hotfixes 206 are treated as modifications to feature design data (or previous hotfixes). When a hotfix 206 needs to be applied, the necessary changes are collected and applied through the hotfix functionality in the design data tool 102. In some cases, the design data tool 102 allows for a streamlined hotfix workflow as compared to other version distributions, while managing related aspects (such as propagation of a hotfix across other pending features). This allows for rapid responses to potential defects, bugs or other unwanted but previously distributed design data.

Variants 208 are used as standing data replacement definitions coupled to pre-defined rules which govern when the respective design data is applied. In some cases, variants 208 are evaluated against every feature 204 and hotfix 206 that is deployed from the design data tool 102. For example, in a virtual environment that includes buildings as elements, a specific building might use different design data in a particular client geographical region (e.g., a billboard in a particular language) and another building might not be available in that region. Such distinctions can be applied using variants 208, coupled to a rule restricting that variant 208 to the region in question. For example, in a virtual environment that includes buildings as elements, it may be desirable to have a particular building “Building A” rendered with different assets in a particular client geographical region (such as a billboard with baked-in translated text). Similarly, it may be desirable to have another particular building “Building B” restricted and unavailable in that region. Such distinctions can be applied using variants 208, coupled to a rule restricting that variant 208 to the region in question. In the example above, “Building A” would have its asset references replaced by the variant 208 data, and “Building B” would be flagged as unavailable in the variant 208 data. Whenever a new feature 204 or hotfix 206 is uploaded, an implicit alternate variant 208 of that data set can be created using the specified design data.

All design data that is uploaded into the design data tool 102 is versioned, and can reside solely in the design data tool 102 until it is deployed to the CDN 112. Features 204 and hotfixes 206 can be explicitly managed by their version number in the design data tool 102, and variants 208 can exist in the design data tool 102 as data replacement definitions. When a feature 204 or hotfix 206 is deployed, the set of existing variants 208 can be used to dynamically generate alternate data sets against a base set of design data.

Variants 208 may also be assigned a unique name/number in the design data tool 102. For example, each uploaded feature 204 can be assigned a new consecutive major version number—for example, 10500, 10501, 10502, etc. Each uploaded hotfix 206 can be assigned a new consecutive minor version number, falling under the applicable major version number (i.e., feature 204). For example, feature 10502 might have three applicable hotfixes, such as 10502.1, 10502.2, and 10502.3. For each variant 208 defined in the design data tool 102, an implicit data variation can exist against each undeployed feature 204 and hotfix 206. These variants 208 may be used to generate data replacement sets during version deployment. These variations need not be explicitly included in the version numbering convention, as they may be grouped in various combinations for each particular client 116 based on their applied rule sets.

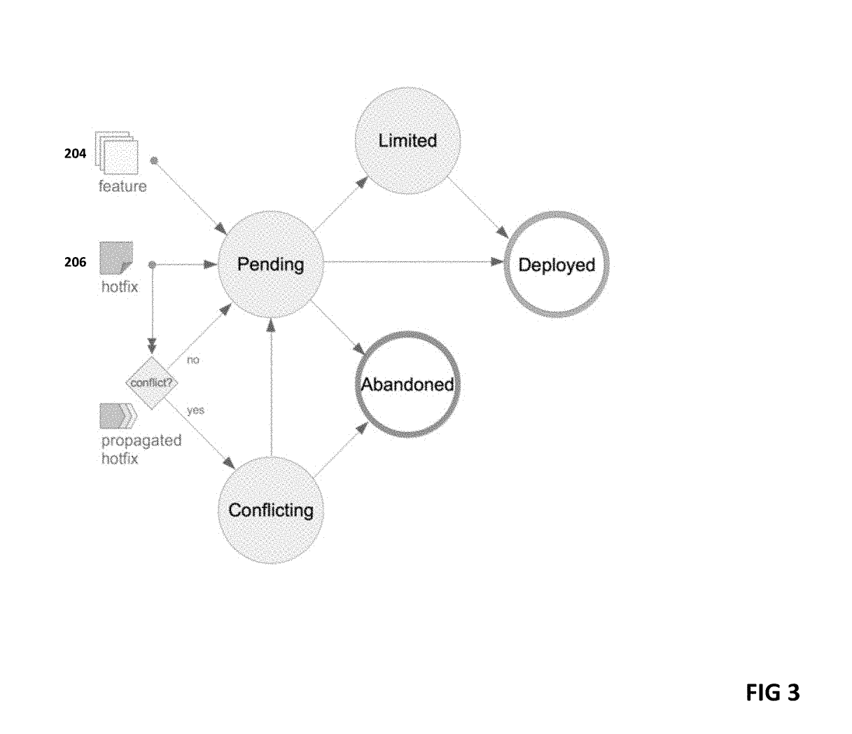

In some cases, version control is managed as a staged process. Referring to FIG. 3, each feature 204 and hotfix 206 is assigned a status, with each status having a corresponding set of workflow parameters and rules for moving from one status to another. In one embodiment, the statuses may include pending (e.g., uploaded into data tool and awaiting action), deployed (e.g., sent to CDN 112), deployed-limited (e.g., deployed but constrained by one or more rules or release dates), conflicting (e.g., a propagated hotfix that conflicts with new design data of a particular feature), and abandoned (e.g., a discarded feature or hotfix). Other statuses are possible.

In some embodiments, workflow rules govern how features 204 and/or hotfixes 206 move from one status to another. Specifically, features 204 and hotfixes 206 can be all initially given a status of “pending” when created. Once deployed to the CDN 112 and available for release to clients 116, features 204 and hotfixes 206 are given a status of deployed. This is a final state/status, as once deployed a feature 204 or hotfix 206 is considered finalized. Features 204 and hotfixes 206 may be deemed “deployed-limited” when they have been deployed to the CDN 112, but done so with attendant rules or release timestamps such that they are not sent to clients 116 until the rules or timestamps are satisfied. Once the rules and/or timestamps have been met, the feature 204 or hotfix 206 may move from “deployed-limited” to “deployed,” at which point all rules and timestamps are removed.

Hotfixes 206 may also be deemed “conflicting” when propagated across features 204 if one or more of the design data items in the hotfix 206 conflict with data changes in the target feature 204 against which the hotfix 206 is to be deployed. If deemed “conflicting,” a hotfix 206 will not be deployed. If the conflict can be resolved, the hotfix 206 can be moved into the pending status, whereas if not, the hotfix 206 will be deemed abandoned. Hotfixes 206 deemed abandoned have been discarded and are ignored for future releases. Moving a hotfix 206 to abandoned status will also abandon all pending and conflicting instances of that hotfix 206 propagated to other features 204. Like “deployed”, “abandoned” is considered a final status and once a hotfix 206 is abandoned it will not be deployed.

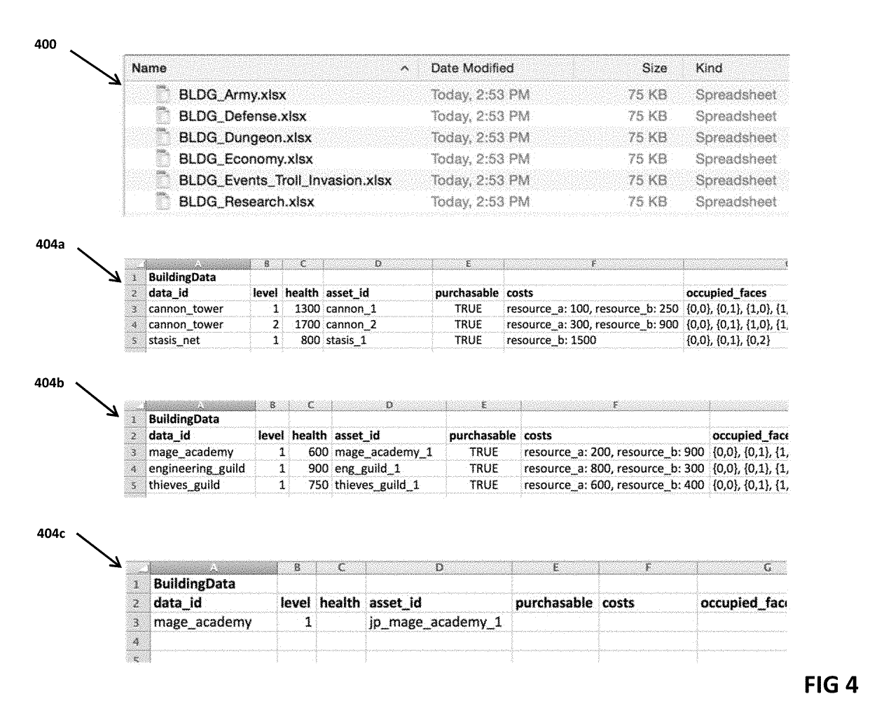

Feature design data may be collected and entered into the data design tool 102 in any number of suitable formats and using various applications, programming interfaces, and forms. For purposes of illustration and not limitation, in one set of embodiments as shown in FIG. 4, a spreadsheet format can be used. In some instances, design data for a particular class of environment elements may be spread across multiple spreadsheets, with the particular class to which the data is being applied identified in the first cell of the spreadsheet file. For example, design data applicable to buildings may belong to a “BuildingData” class and a single spreadsheet 400 may be used to list each spreadsheet file that contains design data for that class. Subordinate spreadsheets 404a and 404b, each identified as belonging to the “BuildingData” class, may then include specific design data for building data elements in the environment, including the level of the environment in which it is instantiated, a unique asset identifier, whether users can purchase the element, the cost, and other parameters associated with the building data element.

When a full set of feature spreadsheets are loaded as a batch, all of the design data applicable to a class can then be collated based on the class designated in each spreadsheet. In some instances, when uploading a new feature some or all of the design data may be inherited from a previous version (by default, the most recent previous feature 204 and hotfix 206), and the newly uploaded feature design data increases or overwrites that data. Hotfix 206 design data may be assembled in the same manner as feature 204 design data. Hotfix 206 design data may include changes to specific data fields on existing element records, or of new records to be added. When modifying an existing record, only the key fields and the fields to be modified need be entered, while fields that are not altered may be left blank, or if the desired change is to clear a field, the string “null” may be entered into that field. Variant 208 design data may also be assembled using the spreadsheet format similar to how hotfix 206 design data is constructed. For example, if certain building assets are to vary for a particular region, a related spreadsheet 404c may be used to create a variant data entry against BuildingData in which, for example, the level 1 mage academy uses the “jp_mage_academy_l” (e.g., for Japan) asset instead of the baseline “mage_academy_1” element.

The design data tool 102 provides functions such as, for example, feature management, hotfix management, variant management, application deployment management, release management, full environment management, and other like functions. The feature management functions of the design data tool 102 can include, for example, validating feature listings/spreadsheets to ensure conformity with formatting parameters, generating reports indicating differences between spreadsheets and to verify changes from one set of design data to the next, uploading feature design datasets into the design data tool, and, in some cases, in-tool editing of undeployed design data, as well as other like functions. The hotfix management functions of the design data tool 102 can include, for example, validating hotfix design data listings/spreadsheets, generating difference reports to verify hotfix changes, uploading hotfix data into the design data tool, propagating uploaded hotfixes into pending feature releases, managing conflicts among hotfixes, and in-tool editing of undeployed hotfix data, as well as other like functions. The variant management functions of the design data tool 102 can include, for example, validating variant design data, generating difference reports to verify variant changes, uploading variant design data to the data tool as either new variants or modifications to existing variants, in-tool editing of variant data, and managing rules that govern each variant, as well as other like functions.

The design data tool 102 may also be used to manage deployment of design data, including, for example, deployment of production data packages to the CDN 112 and deploying data to other, non-production environments for testing, etc. The design data tool 102 may also be used, for instance, to assist with release management, including default releases and timestamp/rule based releases, full deployments of the entire application to one or more environments, as well as data-only deployments and other like functions.

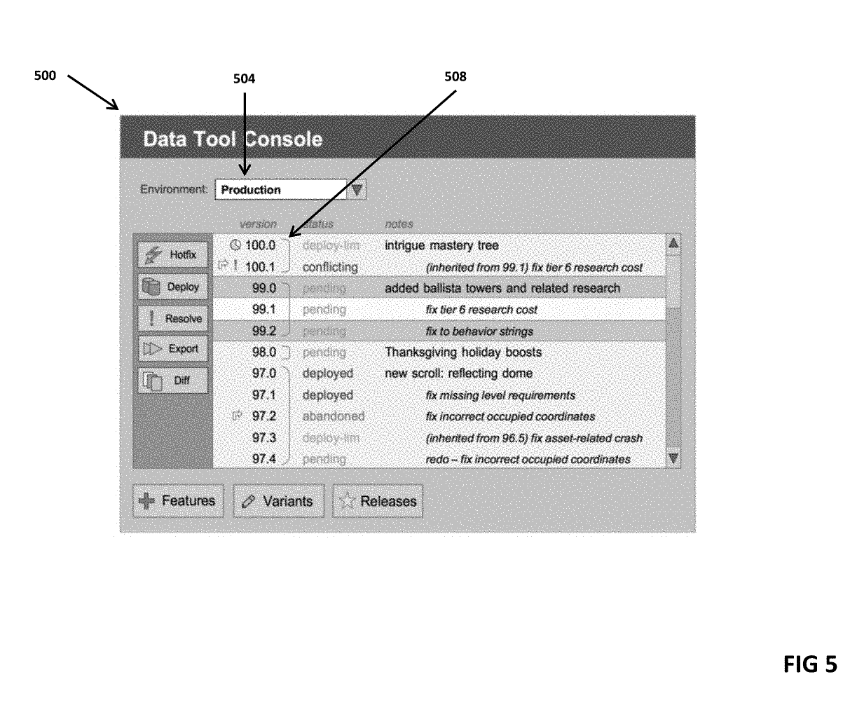

FIGS. 5-13 illustrate various screen captures from the design data tool 102 that may be used to collect and manage the design data. In various implementations of the application and referring specifically to FIG. 5, a design data tool console 500 identifies the environment 504 in which each of the various versions 508 of the design data have been or are awaiting deployment.

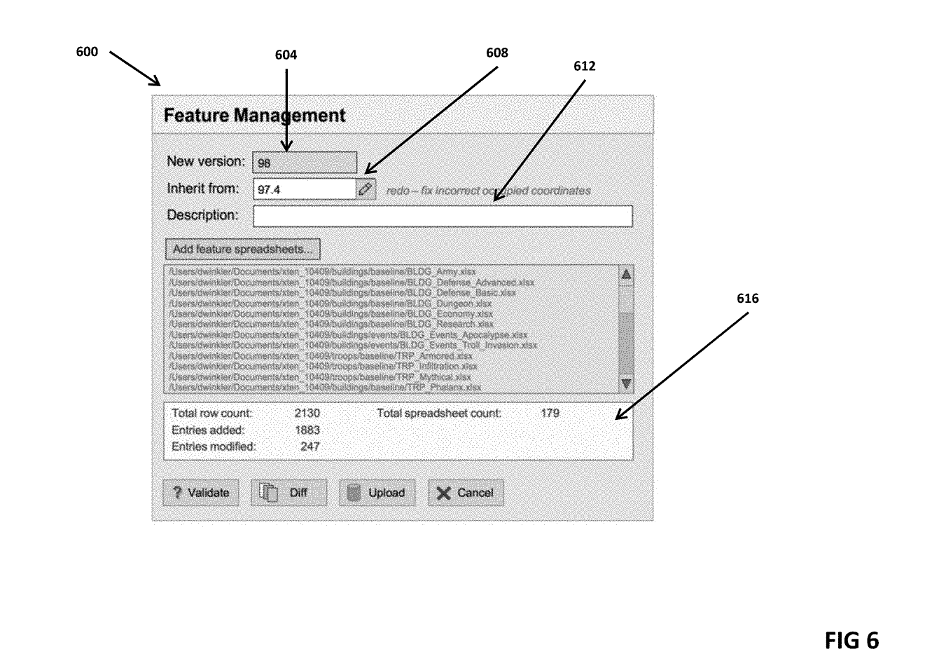

FIG. 6 is an exemplary screen capture 600 from the design data tool 102 application that facilitates the uploading of feature data listings/spreadsheets. With each upload, a new consecutive major version number 604 can be generated. Each new feature 204 may inherit the data from the latest (e.g., to the highest-versioned hotfix 206 of the highest-versioned feature 204) feature/hotfix version 608 as a baseline and can be tagged with a description 612. A “validate” function generates a report 616 on overall data validity for the selected spreadsheets. The report 616 may include, for example, the validity of the status data class specified in the first cell, confirmation that the spreadsheet columns/structure correspond to the defined schema, verification of data types for field inputs, removal or flagging of duplicate entries, and any custom data validations as defined in the data model, as well as other like report data. A “diff” function allows for data comparison of the selected spreadsheets against other versions, thus outlining which records are being added or changed. Once structural validity (via the validate function) and desired changes (via the diff function) have been confirmed, the spreadsheets are uploaded into the design data tool 102.

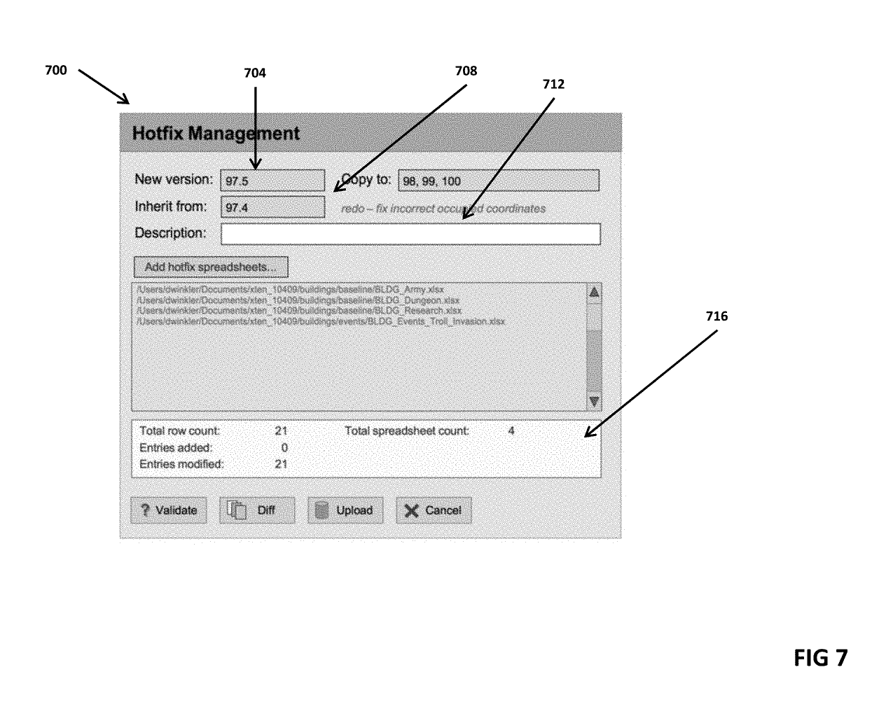

The design data tool 102 also facilitates the uploading of hotfix 206 data associated with existing design elements in the environment. FIG. 7 is an exemplary screen capture 700 of a hotfix management screen within the design data tool 102. When a new hotfix 206 is entered, a new consecutive minor version number 704 can be generated under that feature 204 for each hotfix 206. Hotfixes 206 can inherit from (708) the feature 204 to which they are applied (including previous hotfixes 206), and the same validation/diff/upload functionality applies. Hotfixes 206 may also automatically propagate forward to existing features 204. For example, suppose feature versions 90, 91, 92, and 93 exist in the design data tool 102. Consequently, feature 91 can have one hotfix already applied as 91.1. Furthermore, feature 92 can have two hotfixes already applied (92.1 and 92.2). A new hotfix can be applied to feature 91. The new hotfix version number would be 91.2, which can be carried over twice to create hotfixes 92.3 and 93.1. In this case, hotfix 91.2 is the root hotfix; 92.3 and 93.1 are hotfixes with additional changes based on the root hotfix 91.2. Features 204 uploaded after the hotfix 206 will take the hotfix data into account under the inheritance pattern as described in the feature management section. When propagated hotfixes 206 are created, conflict detection is applied against each forward feature 204. If the propagated hotfix 206 would result in any data changes that differ from the data changes applied by the root hotfix 206, those rows can be marked as conflicts and the propagated hotfix 206 enters the “conflicting” status.

For purposes of illustration and not limitation, if the root hotfix 91.5 changes the “build_time” for the “mage_academy” row from 600 to 900, the root hotfix 91.5 is propagated to feature 92, to create propagated hotfix 92.1. However, in feature 92, the “build_time” for “mage_academy” was set to 1200. Since the “build_time” changes from 600 to 900 in root hotfix 91.5, but from 1200 to 900 in propagated hotfix 92.1, the row is flagged as a conflict and propagated hotfix 92.1 enters the “conflicting” status. Conflicting rows may be resolved in the design data tool 102 by selecting the desired data change (retaining the forward feature change, or overwriting it with the propagated change). If all conflicts in a propagated hotfix 206 are resolved, it moves back to “pending” status. Conflicts are carried forward if a new version inherits from a conflicted version. If a root hotfix 206 is abandoned, all of its propagated hotfixes 206 still in pending status can be abandoned as well.

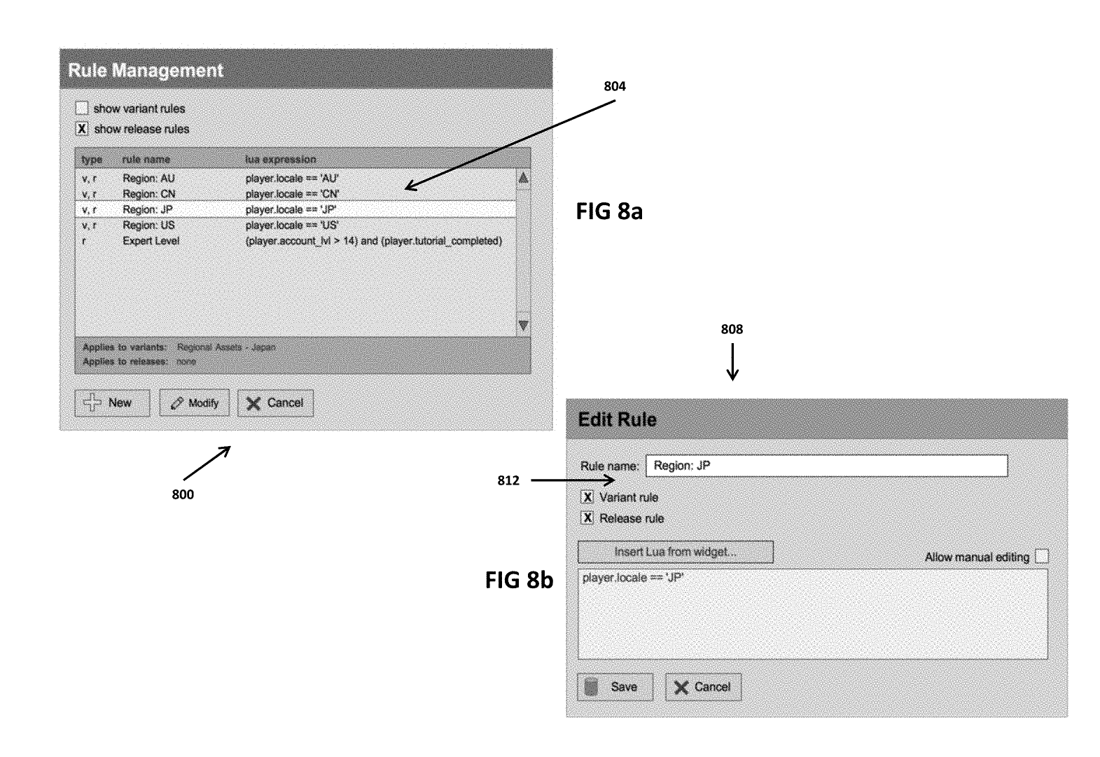

FIGS. 8a and 8b illustrate an exemplary rule management screen 800 in which individual rules may be added, modified and reviewed as a list 804, and rule edit screen 808 in which rules may be named 812 and assigned to a particular variant 208. Rules may be built as widgets using a suitable scripting language (e.g., Lua or the like) and using logical expressions and predefined selections.

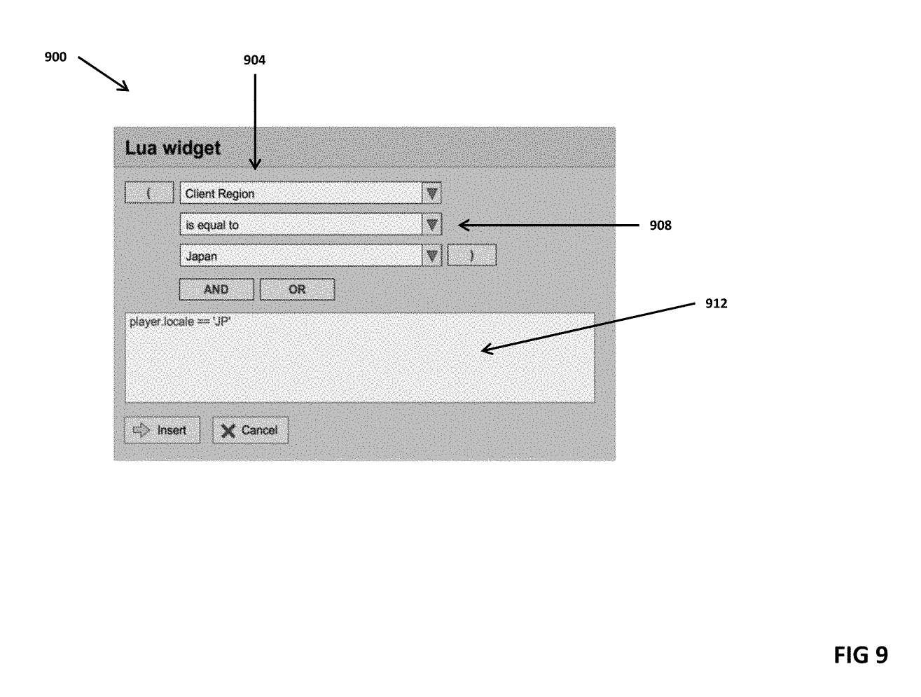

FIG. 9 illustrates a widget screen 900 into which a user may design and insert widgets such that they are available for use in more complex rules. For example, a widget may be created that tests whether a user of the virtual environment is in Japan using known data elements 904 (e.g., client region) and Boolean operators 908, with a resulting rule 912 snippet. In some cases, the rule script code may also be entered manually.

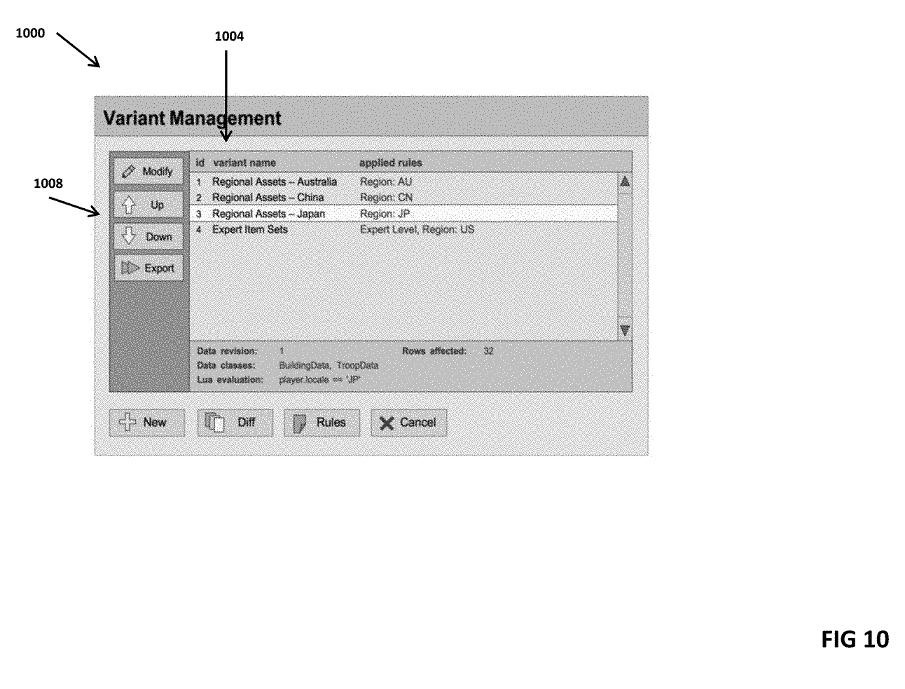

Referring now to FIG. 10, the design data tool 102 may also include a variant management screen 1000 that facilitates the creation and management of data variants 208 as standing data replacement definitions which the design data tool 102 can use to automatically generate alternate static data variations. These variations may deployed to the client 116 based on predefined variant rules, as described above. Unlike features 204 and hotfixes 206, variants 208 need not be managed by a data version number. Rather, they can operate as standing hooks which are triggered upon deployment, generating data variations against each feature/hotfix data package deployed to the CDN 112. When a client 116 verifies its data version via the versioning service 106, it will be directed to retrieve the appropriate subset of applicable variations along with the base feature/hotfix data, and the replacements are deployed to the client 116. The metadata 1004 for each set of variant 208 data can include, for example, a numerical ID, an administrator-supplied variant name, and the set of rules which are coupled to that variant 208. Other metadata is possible. The numerical ID of each variant 208 can also represent its priority in the case of conflicting variations. If multiple variants 208 apply to a particular client 116, and those variants 208 would alter the same data field, then the variant 208 with the lowest numerical ID can take priority. The variant management screen 1000 can allow for variants 208 to be reordered 1008 up or down the list (thus reassigning them to new IDs) to facilitate control over conflict resolution. A “diff” function allows for version comparisons with and without the application of specific variants or rule sets, which allows the user to verify the data variations being applied. An “export” function allows for viewing of a selected variant's data set, along with the ability to save that data to an external file. A “modify” function allows for editing of the variant's name and rule set as well as the variant data itself (using, for example, a spreadsheet upload).

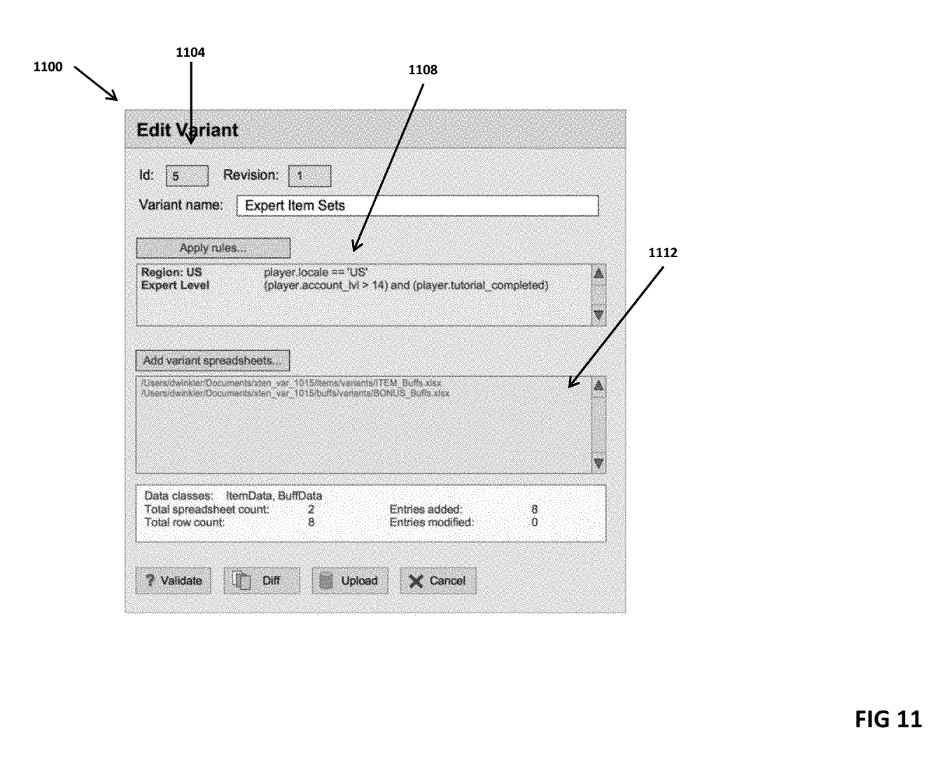

FIG. 11 illustrates an exemplary variant edit screen 1100 of the design data tool 102 in which new variants may be edited and/or created, and assigned a variant ID 1104, with particular rules 1108 and corresponding design data files/spreadsheets 1112. Similar validation/diff/upload functionality is also provided.

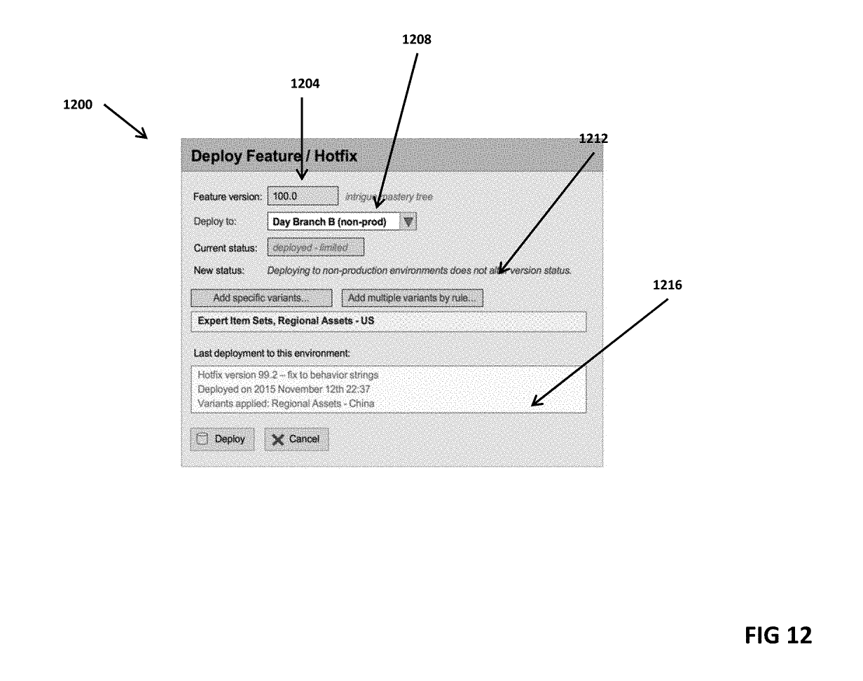

The design data tool 102 also manages the deployment of specific data versions to the CDN 112 and virtual environment server(s) for live distribution, or in some cases to selected non-production development or testing environments. Any number of release rules may be coupled to the deployment and are defined and resolved in the same manner that variant rules are applied to variants 208. In some instances, a release timestamp can be associated with the deployment, and together with the rules define the time and conditions under which the data is deployed to a client 116. FIG. 12 illustrates an exemplary feature/hotfix deploy screen 1200 of the design data tool 102 used to deploy features 204 and hotfixes 206. In this instance, the screen 1200 can include, for example, the feature version number 1204, the environment into which it is being deployed 1208, a status 1212, and a history 1216 of recent deployments to the same environment.

The following steps outline an exemplary process for deploying releases to a production (live) environment. First, the base data for the selected feature 204 or hotfix 206 is packaged and staged locally. Each variant data set is then packaged and deployed to a sub-folder under the primary data package, including priority metadata applicable to that variant 208 which the client will need for parsing. The staged data (“full data package”) is then uploaded to the CDN 112 and indexed by version number. In some cases, a snapshot of all current variants 208 may be retained in a historical variant table and versioned using the feature/hotfix version number, allowing retention of a historically accurate variant mapping as variants 208 are modified over time. The production environment server database is then updated with the new versioned data, and the feature/hotfix enters the “deployed” status in the design data tool 102, or the “deployed-limited” status if any release rules or timestamps are coupled to the deployment. An RTE broadcast is sent (scheduled according to the release timestamp if applicable, or immediately otherwise) to all clients 116 to contact the versioning service 106 to receive the newly released design data. The full data package can be downloaded straight into the appropriate folder structure on the client 116, which will then parse and load the data package directly.

Deployment to non-production environments uses a slightly different workflow. The feature/hotfix data and variants are assembled into a full data package and staged locally, as for live deployments, an additional server data package is assembled and staged, and the full data package and the server package are distributed to the desired environment, directly into the appropriate folder structures. The local server database is then updated with the appropriate versioned data via server load APIs configured to run on test installations.

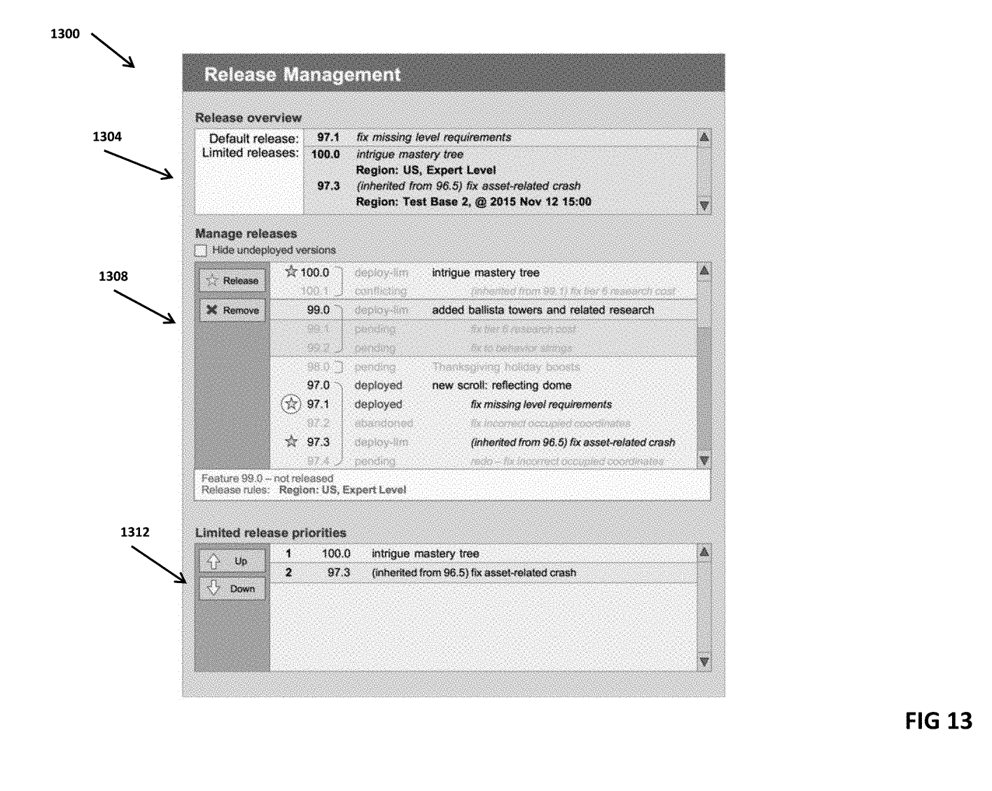

FIG. 13 shows a release management screen 1300 of the design data tool 102. Using this screen, feature/hotfix versions are released to clients 116, in effect selecting the data versions which are considered “live.” When modifying releases, a single feature/hotfix in the “deployed” status is selected as the primary release version, and any number of “deployed-limited” deployment versions may be selected as well, providing an overview 1304 of what is in the release and a hierarchy of the versions 1308. These are assigned a priority ID 1312 (with the “deployed” version last) and are resolved similarly to variants 208—the release rules and timestamps for each version are evaluated in order and the lowest ID takes precedence. Prior versions may be selected for release if a data version rollback is deemed necessary. The release management screen 1300 allows users to configure connection information and metadata for production and non-production environments.

Clients 116 may then confirm their current data version upon login, or whenever prompted to do so via an RTE broadcast. This occurs via a request to the versioning service 106, which processes the request in the following manner. First, each release rule and timestamp is evaluated to determine the release version applicable to the requesting client 116, and each variant rule is evaluated to determine its applicability. A manifest is then generated referencing the appropriate data package (including the base data and only those specific variant sub-folders which are applicable to this client) and sent to the client 116. Each versioning service 106 response is logged along with applicable user metadata, allowing a backtrace to a client's data set history for troubleshooting purposes.

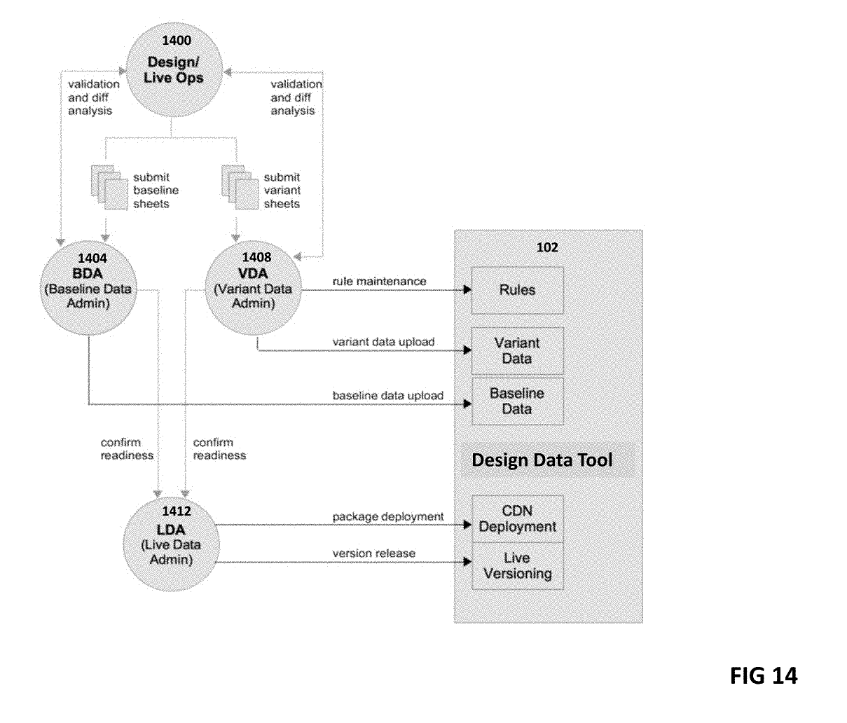

FIG. 14 illustrates an exemplary workflow and role/responsibility flowchart for the design and deployment of design data for the virtual environment according to certain embodiments of the invention. A Design/Live Operations (Ops) Team 1400 assembles baseline data in the specified spreadsheet or other suitable form or format and submits baseline data to the Baseline Data Administrator (“BDA”) 1404. The Design/Live Ops Team 1400 also assembles variant data in Excel spreadsheet or other appropriate form and submits variant data to a Variant Data Administrator (“VDA”) 1408. The BDA 1404 uploads spreadsheets via the design data tool 102, confirms success or analyzes errors, obtains version diffs from the design data tool 102 as needed and verifies changes between major versions. The VDA 1408 maintains variant rulesets in the design data tool 102, creates rulesets and uploads applicable spreadsheets, generates variant versions from the supplied rulesets, obtains the variant diffs from the design data tool 102 as needed, verifies changes applied by variants, and analyzes data variant conflicts for correctness. A Live Data Administrator (“LDA”) 1412 coordinates data deployments, verifies version readiness with the BDA 1404 and VDA 1408, and deploys data packages to the CDN 112.

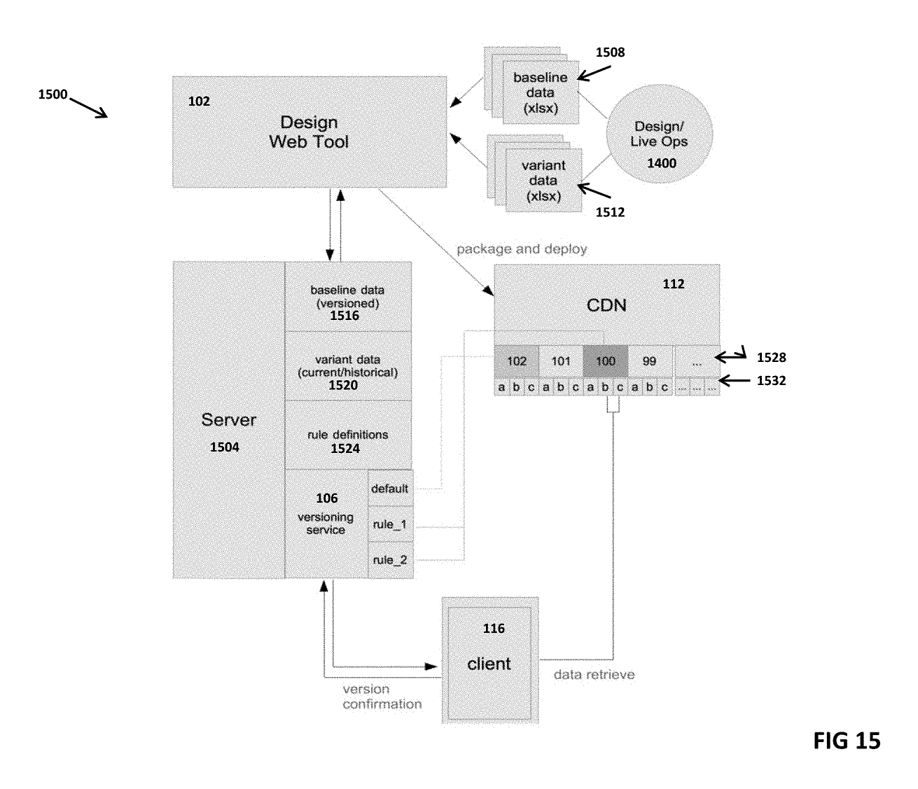

FIG. 15 is a more detailed illustration of one embodiment of a system 1500 that may be used to implement the techniques described herein. As described with reference to FIG. 1, the design data tool 102 may be implemented as a web-based application for users to enter, manage and deploy design data used to customize a virtual environment. A centralized server 1504 (or in some cases an array of servers) hosts the versioning service 106, and stores various data used by the design data tool 102. As described above, a Design/Live Ops Team 1400 uses the design data tool 102 along with baseline data 1508 and variant data 1512 to create a set of versioned baseline data 1516 and associated variant data 1520, which may also include one or more rules 1524. The baseline data 1508, variant data 1520, and rules 1524 are combined by the versioning service 106 into deployed versions 1528, each having one or more variants 1532. Clients 116 can then retrieve specific versions and the appropriate variants (based, for example, on one or more client parameters or characteristics) from the CDN 112, as well as retrieve version confirmation information from the versioning service 106.

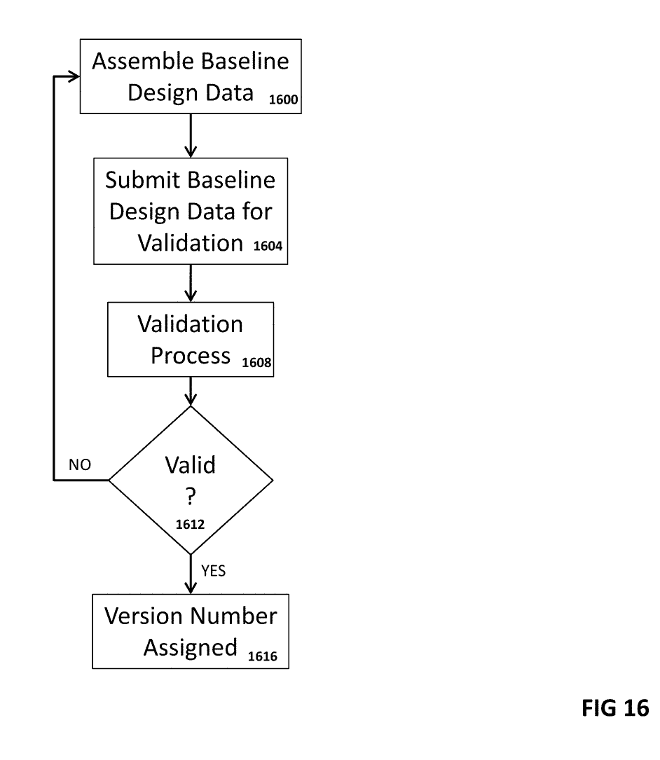

FIG. 16 is a flow chart illustrating the general processes for creating a set of baseline design data that may be used in subsequent versions. In step 1600, members of a design team assemble baseline design data in the specified format (e.g., spreadsheets or other suitable format). The spreadsheets containing the baseline design data are submitted (step 1604) to the BDA for validation, where the BDA verifies (step 1608) the spreadsheets are in the proper form using the validate and diff functions described above. If the baseline design data is properly formatted and verified (decision step 1612), the baseline design data is accepted and automatically assigned a version number (step 1616). If the data does not pass validation step, it is returned to the design team to resolve any issues in the baseline design data.

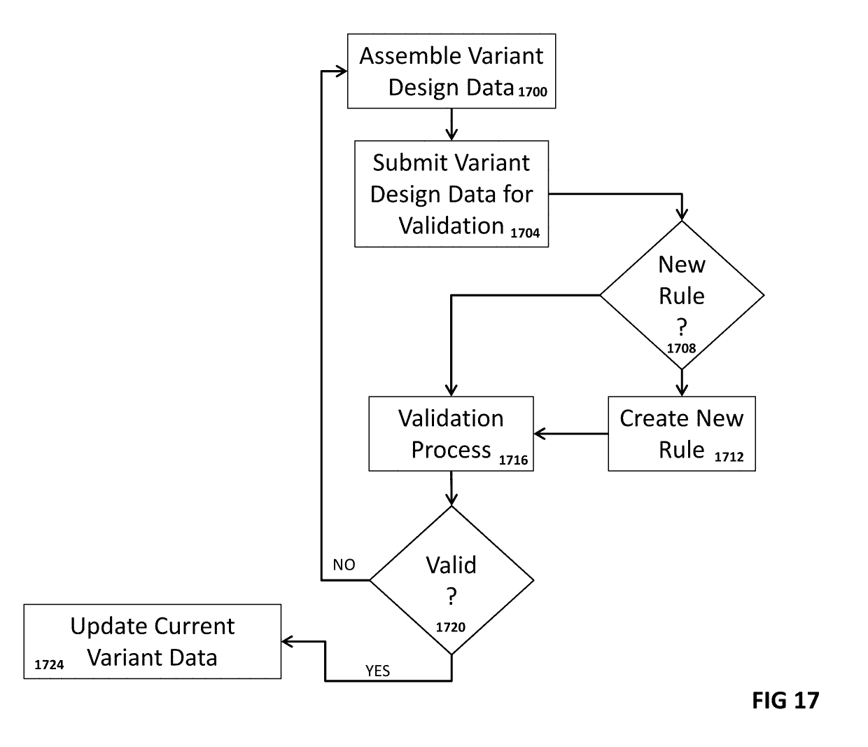

FIG. 17 is a flow chart illustrating the process for creating variant data. Similar to the baseline design data creation process, in step 1700, members of a design team assemble variant design data in the specified format (e.g., spreadsheets or other suitable format) for a new variant. The spreadsheets containing the variant design data are submitted (step 1704) to the VDA for validation. The VDA then determines if a new rule is being implemented in the new variant (decision step 1708). If a new rule is being implemented, the new rule is created (step 1712). In either event, the process continues to the validation process where the VDA verifies (step 1716) the spreadsheets are in the proper form using the validate and diff functions described above. If the variant design data is properly formatted and verified (decision step 1720), the variant design data is uploaded and a new variant is created (step 1724). If the data does not pass validation step, it is returned to the design team to resolve any issues so that the variant can move forward to deployment.

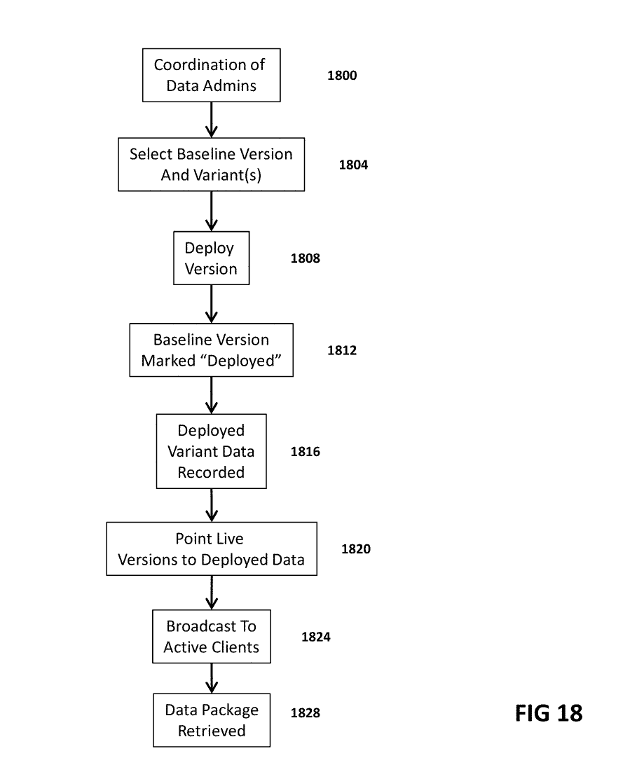

FIG. 18 is a flowchart illustrating the process for creating and deploying a new version. Initially, the LDA coordinates with the BDA and VDA (step 1800) to verify that the data supporting the version is ready to be deployed. The LDA then selects a baseline version and a subset of variant(s) (step 1804) that will comprise the version. The LDA then deploys the selected version and any associated variant(s) into a data package for the CDA (step 1808). The baseline version is marked as deployed (step 1812) and the variant data is recorded as being applied to that version (step 1816). The LDA then updates live versions to point to the newly deployed design data package (step 1820) and initiates an RTE broadcast to clients (step 1824), which then initiates the retrieval of the design data package (step 1828) by the client(s).

By allowing the BDA and VDA teams to create and deploy design data that can create new experiences, as well as fix or augment previously released versions, without requiring a complete release of an entire codebase, users can be presented with new experiences almost continuously and at a level of granularity not previously permitted.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic disks, magneto-optical disks, optical disks, or solid state drives. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including, by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse, a trackball, a touchpad, or a stylus, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what can be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features can be described above as acting in certain combinations and even initially claimed as such, one or more features from a claimed combination can in some cases be excised from the combination, and the claimed combination can be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing can be advantageous.

What is claimed is:

1. A method, comprising:
receiving a plurality of design parameters for a virtual environment, the virtual environment comprising elements defined by the design parameters and a primary functional codebase;
creating, by one or more computer processors, one or more versions of the virtual environment, each version comprising a subset of the design parameters independent of the primary functional codebase;
assigning, by the one or more computer processors, one of the one or more versions to a user of the virtual environment; and
distributing the one of the one or more versions to the user of the virtual environment without requiring distribution of the primary functional codebase.

2. The method of claim 1, wherein the distribution of the one or more versions is in response to a request from the user associated with the one of the one or more versions.

3. The method of claim 1, wherein the distribution of the one or more versions is in response to the user instantiating the virtual environment on a client device.

4. The method of claim 1, wherein the virtual environment provides a setting for an online multi-player game.

5. The method of claim 1, further comprising:
assigning subsequent versions of the one or more versions to subsequent users of the virtual environment, such that each user interacts with the virtual environment according to the users' assigned version.

6. The method of claim 1, wherein at least one of the one or more versions inherits a subset of design parameters from a previous version.

7. The method of claim 1, wherein the design parameters comprise one or more of new design data and modifications to existing design data.

8. The method of claim 1, further comprising creating one or more variants of each version.

9. The method of claim 1, further comprising:
prior to distributing the one of the one or more versions to the user of the virtual environment, designating the one of the one or more versions as subject to one or more release rules such that the release occurs only when the rules are satisfied.

10. The method of claim 1 further comprising:
prior to distributing the one of the one or more versions to the user of the virtual environment, determining if the one of the one or more versions conflicts with a design parameter of a previously released version, and not permitting release of the one of the one or more versions until such conflict is designated as resolved or the conflicting design parameter is abandoned.

11. A system, comprising:
one or more computer processors programmed to perform operations comprising:
receiving a plurality of design parameters for a virtual environment, the virtual environment comprising elements defined by the design parameters and a primary functional codebase;
creating, by one or more computer processors, one or more versions of the virtual environment, each version comprising a subset of the design parameters independent of the primary functional codebase;
assigning, by the one or more computer processors, one of the one or more versions to a user of the virtual environment; and
distributing the one of the one or more versions to the user of the virtual environment without requiring distribution of the primary functional codebase.

12. The system of claim 11, wherein the distribution of the one or more versions is in response to a request from the user associated with the one of the one or more versions.

13. The system of claim 11, wherein the distribution of the one or more versions is in response to the user instantiating the virtual environment on a client device.

14. The system of claim 11, wherein the virtual environment provides a setting for an online multi-player game.

15. The system of claim 11, further comprising:
assigning subsequent versions of the one or more versions to subsequent users of the virtual environment, such that each user interacts with the virtual environment according to the users' assigned version.

16. The system of claim 11, wherein at least one of the one or more versions inherits a subset of design parameters from a previous version.

17. The system of claim 11, wherein the design parameters comprise one or more of new design data and modifications to existing design data.

18. The system of claim 11, further comprising creating one or more variants of each version.

19. The system of claim 11, further comprising:
prior to distributing the one of the one or more versions to the user of the virtual environment, designating the one of the one or more versions as subject to one or more release rules such that the release occurs only when the rules are satisfied.

20. The system of claim 11 further comprising:
prior to distributing the one of the one or more versions to the user of the virtual environment, determining if the one of the one or more versions conflicts with a design parameter of a previously released version, and not permitting release of the one of the one or more versions until such conflict is designated as resolved or the conflicting design parameter is abandoned.

21. A non-transitory computer-readable medium having instructions stored thereon that, when executed by one or more computer processors, cause the computer processors to perform operations to:
receive a plurality of design parameters for virtual environment, the virtual environment comprising elements defined by the design parameters and a primary functional codebase;
create one or more versions of the virtual environment, each version comprising a subset of the design parameters independent of the primary functional codebase;
assign one of the one or more versions to a user of the virtual environment; and
distribute the one of the one or more versions to the user of the virtual environment without requiring distribution of the primary functional codebase.
